(19) United States
(12) Patent Application Publication
(10) Pub. No.: US 2022/0320580 A1
(43) Pub. Date: Oct. 6, 2022

(54) ALL-SOLID-STATE BATTERY

(71) Applicant: TOYOTA JIDOSHA KABUSHIKI KAISHA, Toyota-shi (JP)

(72) Inventors: Hideaki NISHIMURA, Suntou-gun (JP); Jun YOSHIDA, Suntou-gun (JP); Mitsutoshi OTAKI, Susono-shi (JP); Satoshi WAKASUGI, Susono-shi (JP); Shoshei KAWASHIMA, Susono-shi (JP); So YUBUCHI, Susono-shi (JP)

(21) Appl. No.: 17/655,859

(22) Filed: Mar. 22, 2022

(30) Foreign Application Priority Data
Mar. 31, 2021 (JP) 2021-059827

(51) Int. Cl. H01M 10/0562; H01M 4/58

(52) U.S. Cl. CPC H01M 10/0562; H01M 4/5815

(57) ABSTRACT

To reduce an electric resistance of an all-solid-state battery, the all-solid-state battery includes: an anode active material layer; a cathode active material layer; and a solid electrolyte layer disposed between the anode active material layer and the cathode active material layer, wherein the cathode active material layer contains S, Li₂S, P₂S₅, and a single-walled carbon nanotube.

### FIELD

The present disclosure relates to an all-solid-state battery.

### BACKGROUND

An all-solid-state battery is provided with a cathode including a cathode active material layer, an anode including an anode active material layer, and a solid electrolyte layer disposed between them and containing a solid electrolyte.

For example, Patent Literature 1 exemplifies an all-solid-state lithium sulfur battery having a positive electrode mixture that contains sulfur or Li₂S that is a discharge product thereof, and a carbon nanotube (CNT) as a conductive aid.

Patent Literature 2 discloses an all-solid lithium sulfur battery having a positive electrode mixture that contains S, Li₂S, a conductive aid and a solid electrolyte, wherein as the conductive aid, a carbon material such as acetylene black and Ketjenblack is used.

### CITATION LIST

### Patent Literature

Patent Literature 1: JP 2014-160572 A
Patent Literature 2: JP 2018-026199 A

### SUMMARY

### Technical Problem

An object of the present disclosure is to provide an all-solid-state battery capable of reducing the electric resistance thereof.

### Solution to Problem

As one aspect to solve the above problem, the present disclosure discloses an all-solid-state battery comprising: an anode active material layer; a cathode active material layer; and a solid electrolyte layer disposed between the anode active material layer and the cathode active material layer, wherein the cathode active material layer contains S, Li₂S, P₂S₅, and a single-walled carbon nanotube.

### Advantageous Effects

The all-solid-state battery according to the present disclosure is capable of reducing the electric resistance thereof.

### BRIEF DESCRIPTION OF DRAWINGS

FIG. 1 explanatorily shows a layer structure of an all-solid-state battery 10.

### DESCRIPTION OF EMBODIMENTS

All-Solid-State Battery

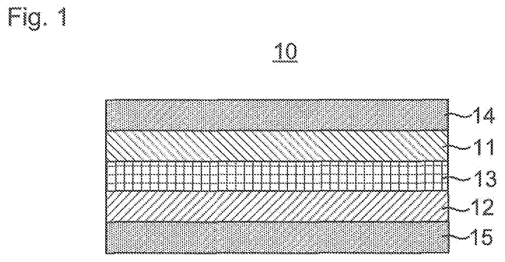

FIG. 1 is a schematic cross-sectional view of an all-solid-state battery 10 according to one embodiment of the present disclosure. The all-solid-state battery 10 according to this embodiment has a cathode active material layer 11 containing a cathode active material, an anode active material layer 12 containing an anode active material, a solid electrolyte layer 13 formed between the cathode active material layer 11 and the anode active material layer 12, a cathode current collector layer 14 configured to collect a current of the cathode active material layer 11, and an anode current collector layer 15 configured to collect a current of the anode active material layer 12. The cathode active material layer 11 and the cathode current collector layer 14 may be called together a cathode. The anode active material layer 12 and the anode current collector layer 15 may be called together an anode.

Hereinafter each of the components of the all-solid-state battery 10 will be described.

### 1.1. Cathode Active Material Layer

The cathode active material layer 11 is a layer containing a cathode active material, a conductive aid, and a solid electrolyte material, and may further contain a binder if necessary.

In the present disclosure, the cathode active material contains S (sulfur) and Li₂S.

The cathode active material layer contains the cathode active material preferably in the range of 60 mass % and 99 mass %.

S mass/Li₂S mass that is a mass ratio of S and Li₂S in the cathode active material is preferably at most 3.0, more preferably 0.3 to 1, and further preferably 0.3 to 0.5. S mass/Li₂S mass of such a ratio makes it possible to more surely reduce the electric resistance of the all-solid-state battery.

A particle diameter of the cathode active material is not particularly limited, but for example, is preferably in the range of 5 μm and 50 μm. Here, in this description, “particle diameter” means a particle diameter (D50) at a 50% integrated value in a volume-based particle diameter distribution that is measured using a laser diffraction and scattering method.

In the present disclosure, the cathode active material layer contains a single-walled carbon nanotube (SWCNT) as a conductive aid.

A length of the SWCNT that has a fibrous form is preferably 2 μm to 5 μm, which makes it possible to more surely reduce the electric resistance.

In the present disclosure, the solid electrolyte contains P₂S₅. More specific examples of the solid electrolyte include P₂S₅, Li₂S—P₂S₅, Li₂S—P₂S₅—LiI, Li₂S—P₂S₅—Li₂O, Li₂S—P₂S₅—Li₂O—LiI, Li₂S—SiS₂—P₂S₅—LiI, Li₂S—B₂S₃, and Li₂S—P₂S₅-ZmSn (m and n are positive numbers, and Z is any of Ge, Zn and Ga).

The binder is not particularly limited as long as being chemically and electrically stable. Examples of the binder include fluorine-based binders such as polyvinylidene fluoride (PVDF) and polytetrafluoroethylene (PTFE), rubber-based binders such as styrene-butadiene rubber (SBR), olefinic binders such as polypropylene (PP) and polyethylene (PE), and cellulose-based binders such as carboxymethyl cellulose (CMC).

A content of the binder in the cathode active material layer is not particularly limited. For example, the cathode active material layer contains the binder in the range of 0.1 wt % and 10 wt %.

A shape of the cathode active material layer 11 may be the same as that of any conventional one. Particularly, from a viewpoint that the all-solid-state battery 10 can be easily formed, the cathode active material layer 11 is preferably in the form of a sheet. In this case, a thickness of the cathode active material layer 11 is, for example, preferably 0.1 μm to 1 mm, and more preferably 1 μm to 150 μm.

### 1.2 Anode Active Material Layer

The anode active material layer 12 is a layer containing at least an anode active material, and may contain at least one of a solid electrolyte, a conductive aid and a binder if necessary. The binder may be considered in the same manner as for the cathode active material layer 11.

There is no particular limitation on the anode active material. When a lithium ion battery is formed, examples of the anode active material include carbon materials such as graphite and hard carbon, various oxides such as lithium titanate, Si and Si alloys, and metallic lithium and lithium alloys.

A particle diameter of the anode active material is not particularly limited either, but is preferably 0.4 μm to 4.0 μm.

The solid electrolyte is preferably an inorganic solid electrolyte because the inorganic solid electrolyte has high ionic conductivity and is excellent in heat resistance, compared with the organic polymer electrolyte. Examples of inorganic solid electrolytes include sulfide solid electrolytes and oxide solid electrolytes.

Examples of sulfide solid electrolyte materials having Li-ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (m and n are positive numbers, and Z is any of Ge, Zn and Ga), Li₂S—GeS₂, Li₂S—SiS₂—Li₃PO₄ and Li₂S—SiS₂-LixMOy (x and y are positive numbers, and M is any of P, Si, Ge, B, Al, Ga and In). The expression “Li₂S—P₂S₅” means any sulfide solid electrolyte material made with a raw material composition containing Li₂S and P₂S₅. The same is applied to the other expressions.

Examples of oxide solid electrolyte materials having Li-ion conductivity include compounds having a NASICON-like structure. Examples of compounds having a NASICON-like structure include compounds (LAGP) represented by the general formula Li₁₊ₓAlₓGe₂₋ₓ(PO₄)₃ (0≤x≤2), and compounds (LATP) represented by the general formula Li₁₊ₓAlₓTi₂₋ₓ(PO₄)₃ (0≤x≤2). Other examples of the oxide solid electrolyte materials include LiLaTiO (such as Li_{0.34}La_{0.51}TiO₃), LiPON (such as Li_{2.9}PO_{3.3}N_{0.46}) and LiLaZrO (such as Li₇La₃Zr₂O₁₂).

A content of the solid electrolyte in the anode active material layer 12 is not particularly limited. For example, the anode active material layer 12 contains the solid electrolyte in the range of 1 wt % and 50 wt %.

The conductive aid is not particularly limited. A carbon material such as acetylene black and Ketjenblack, or a metallic material such as nickel, aluminum and stainless steel may be used.

The anode active material layer 12 is preferably in the form of a sheet from a viewpoint that the all-solid-state battery 10 can be easily formed. Specifically, a thickness of the anode active material layer 12 is, for example, preferably 0.1 μm to 1 mm, and more preferably 1 μm to 150 μm.

### 1.3. Solid Electrolyte Layer

The solid electrolyte layer 13 is a layer disposed between the cathode active material layer 11 and the anode active material layer 12, and containing a solid electrolyte. The solid electrolyte layer 13 contains at least a solid electrolyte. The solid electrolyte may be considered in the same manner as the solid electrolyte material described for the anode active material layer 12.

For example, the solid electrolyte layer 13 contains the solid electrolyte in the range of 50 wt % and 99 wt %.

The solid electrolyte layer 13 may optionally contain a binder. The binder same as that used for the cathode active material layer 11 may be used. A content of the binder in the solid electrolyte layer is not particularly limited. For example, the solid electrolyte layer contains the binder in the range of 0.1 wt % and 10 wt %.

### 1.4. Current Collector Layers

The current collectors are the cathode current collector layer 14 configured to collect a current of the cathode active material layer 11, and the anode current collector layer 15 configured to collect a current of the anode active material layer 12. Examples of the material constituting the cathode current collector layer 14 include stainless steel, aluminum, nickel, iron, titanium and carbon. Examples of the material constituting the anode current collector layer 15 include stainless steel, copper, nickel and carbon.

Thicknesses of the cathode current collector layer 14 and the anode current collector layer 15 are not particularly limited, but may be suitably set according to a desired battery performance. For example, the thicknesses are each in the range of 0.1 μm and 1 mm.

### 1.5. Battery Case

The all-solid-state battery may be provided with a battery case that is not shown. The battery case is a case to house each member. An example of the battery case is a stainless battery case.

### 2. Method of Manufacturing All-Solid-State Battery

A method of manufacturing an all-solid-state battery is not particularly limited, but may be according to a known method. One example will be described below.

[Preparing Cathode Structure]

The material to constitute the cathode active material layer is mixed and kneaded, and then the resultant slurry cathode composition (cathode mixture) is obtained. Thereafter a surface of the material to be the cathode current collector layer is coated with the prepared slurry cathode composition to be subjected to drying by heating, to form a layer to be the cathode active material layer thereon. Pressure is applied to the resultant. Then, the resultant cathode structure having a layer to be the cathode current collector layer and the layer to be the cathode active material layer is obtained.

[Preparing Anode Structure]

The material to constitute the anode active material layer is mixed and kneaded, and then the resultant slurry anode composition is obtained. Thereafter a surface of the material to be the anode current collector layer is coated with the prepared slurry anode composition to be subjected to drying by heating, to form a layer to be the anode active material layer thereon. Pressure is applied to the resultant. Then, the resultant anode structure having a layer to be the anode current collector layer and the layer to be the anode active material layer is obtained.

When the anode active material is metallic lithium, a lithium alloy, or the like, the anode structure can be formed by using lithium metal foil, and stacking the layer to be the anode current collector layer on this foil.

[Preparing Solid Electrolyte Layer Structure]

The material to constitute the solid electrolyte layer is mixed and kneaded, and then the resultant slurry solid electrolyte layer composition is obtained. Thereafter a surface of foil is coated with the prepared slurry solid electrolyte layer composition to be subjected to drying by heating, to form a layer to be the solid electrolyte layer thereon. Then, the resultant solid electrolyte layer structure having the foil and the layer to be the solid electrolyte layer is obtained.

[Combining Each Structure]

The layer to be the solid electrolyte layer in the solid electrolyte layer structure and the layer to be the cathode active material layer in the cathode structure are laminated, and the foil in the solid electrolyte structure is removed. Then, the layer to be the solid electrolyte is transferred on the cathode structure.

The layer to be the anode active material layer in the anode structure is further stacked onto the transferred layer to be the solid electrolyte. Then the resultant all-solid-state battery is obtained.

### 3. Effect Etc

The all-solid-state battery according to the present disclosure has the cathode active material layer that contains Li₂S, S, P₂O₅, and a single-walled carbon nanotube, thereby capable of reducing the electric resistance of the battery. This is imagined to be because the single-walled carbon nanotube (SWCNT), which is a conductive aid, makes it easy to secure an electron conduction path, and the internal stress in the cathode active material layer decreases because Li₂S does not expand in charging and discharging, which make it possible for an electron conduction path to be secured, and make it possible to reduce the electric resistance.

### 4. EXAMPLES

### 4.1. Preparing all-Solid-State Battery According to Each Example

### Example 1

### <Preparing Cathode Mixture>

The following were weighed: 0.64 g of S (elemental sulfur); 0.64 g of Li₂S; 0.46 g of P₂S₅; and 0.3 g of a SWCNT (TUBALL by OCSiAl), and the raw material mixture thereof was put into ajar (45 cc, made from ZrO₂) for planetary ball milling. Further, 80 g of ZrO₂ balls of 4 mm in diameter was put in the jar, and the jar was completely sealed. The used jar for planetary ball milling and ZrO₂ balls had been dried overnight at 60° C.

The sealed jar was attached to a planetary ball mill machine of P7 manufactured by Fritsch, and subjected to mechanical milling for 6 hours in total in which one cycle of 1-hour mechanical milling at 400 rpm in disk rotation speed, a 15-minute rest, 1-hour mechanical milling reversely at 400 rpm in disk rotation speed, and a 15-minute rest was repeated. Then, a cathode mixture (composition to be a cathode active material layer) was obtained.

<Preparing All-Solid-State Battery>

Into a ceramic mold of 1 cm², 100 mg of P₂S₅ (particle diameter (D50)=2.0 μm) that was a solid electrolyte was added and pressed at 1 ton/cm². Thus, the resultant solid electrolyte layer was obtained.

On one side of the obtained solid electrolyte layer, 7.8 mg of the obtained cathode mixture was added and pressed at 6 ton/cm². Then, a cathode active material layer stacked on the solid electrolyte layer was obtained.

On the other side of the obtained solid electrolyte layer, lithium metal foil to be an anode active material layer was disposed and pressed at 1 ton/cm². Then, the resultant electric element was obtained. The obtained electric element was restrained at a restraining force of 2N·m, to form an all-solid-state battery.

### Examples 2 and 3, Comparative Example 1

All-solid-state batteries were obtained in the same manner as in Example 1 except that the materials were the same as in Example 1 but the added amounts were changed as shown in Table 1.

### Comparative Example 2

An all-solid-state battery was obtained in the same manner as in Example 1 except that the SWCNT in Example 1 which was a conductive aid was changed to vapor grown carbon fiber (VGCF™-H by SHOWA DENKO K.K.), and that the added amount thereof was as shown in Table 1.

Table 1 shows the amounts of S, Li₂S and P₂S₅, a type and the amount of the conductive aid, and the ratio represented by S/Li₂S.

TABLE 1

| | S | Li₂S | S/Li₂S | P₂S₅ | Conductive aid | |
|---|---|---|---|---|---|---|
| | Amount (g) | Amount (g) | (—) | Amount (g) | Type | Amount (g) |
| Comparative | 1.24 | 0 | — | 0.46 | SWCNT | 0.3 |
| Example 1 | | | | | | |
| Comparative | 0.64 | 0.64 | 1 | 0.46 | VGCF-H | 0.3 |
| Example 2 | | | | | | |
| Example 1 | 0.64 | 0.64 | 1 | 0.46 | SWCNT | 0.3 |
| Example 2 | 0.31 | 0.93 | 0.3 | 0.46 | SWCNT | 0.3 |
| Example 3 | 0.93 | 0.31 | 3 | 0.46 | SWCNT | 0.3 |

### 4.2. Evaluation of Battery

### [Resistance]

A charge-discharge test was done on the all-solid-state batteries obtained in Examples 1 to 3 and Comparative Examples 1 and 2. The charge-discharge test was performed using a medium current charge-discharge system (manufactured by Toyo System Co., Ltd.) at 0.46 mA in CC charging and discharging.

Specifically, the response in the following conditions was measured by an impedance device (manufactured by Solartron) after discharge through the three cycles: voltage swing: 10 mV; frequency range: 0.1 Hz to 1000 kHz. A magnitude of a Z′ component up to 0.1 Hz was evaluated as a resistance.

Magnitudes of resistances obtained in Examples 1 to 3 and Comparative Example 2 were represented by ratio when the resistance obtained in Comparative Example 1 was regarded as 100. The results are shown in Table 2 as “resistance ratio”.

[Capacity]

It was confirmed how much an actual capacity of the cathode active material layer was realized to a theoretical capacity thereof in each of Examples 1 and 2 and Comparative Example 1.

Specifically, the theoretical capacity of the cathode active material layer was obtained by the following equation (1). In contrast, the discharge capacity (test capacity) of the all-solid-state battery of each of Examples after discharge and charge through the seven cycles was obtained in the same conditions as those for the above evaluation of the resistance, and the proportion of the test capacity to the theoretical capacity was calculated by the equation (2). The results are shown in Table 2 as “capacity proportion”.

theoretical capacity (mAh/g)={theoretical capacity of S×mass of S/(mass of S+mass of Li₂S)+theoretical capacity of Li₂S×mass of Li₂S/(mass of S+mass of Li₂S)}×{(mass of S+mass of Li₂S)/(mass of S+mass of Li₂S+mass of P₂S₅+mass of the conductive aid)} Equation (1)

capacity proportion (%)={test capacity/theoretical capacity}×100% Equation (2)

4.3. Results

TABLE 2

| | Resistance ratio | Capacity proportion (%) |
|---|---|---|
| Comparative Example 1 | 100 | 62.8 |
| Comparative Example 2 | 93.0 | — |
| Example 1 | 37.0 | 72.8 |
| Example 2 | 41.1 | 72.9 |
| Example 3 | 84.1 | — |

As can be seen from Table 2, each of the resistance ratios was able to much decrease in Examples 1 to 3 compared to Comparative Examples 1 and 2. Among them, each of the resistance ratios notably decreased in particular in Examples 1 and 2, where S/Li₂S was at most 1.

It can be also seen that each of the capacity proportions in Examples 1 and 2 was higher than that in Comparative Example 1.

### REFERENCE SIGNS LIST

10 all-solid-state battery
11 cathode active material layer
12 anode active material layer
13 solid electrolyte layer
14 cathode current collector layer
15 anode current collector layer

What is claimed is:

1. An all-solid-state battery comprising:
an anode active material layer;
a cathode active material layer; and
a solid electrolyte layer disposed between the anode active material layer and the cathode active material layer,
wherein the cathode active material layer contains S, Li₂S, P₂S₅, and a single-walled carbon nanotube.
